(19) United States
(12) Patent Application Publication
(10) Pub. No.: US 2015/0332804 A1
(43) Pub. Date: Nov. 19, 2015

(54) DEPOSITION OF ELECTRICALLY CONDUCTIVE POLYMERS

(71) Applicant: Surface Innovations Limited, Milton Park, Abington, Oxfordshire (GB)

(72) Inventors: Thomas J. WOOD, Durham (GB); Jas Pal Singh BADYAL, Durham (GB)

(73) Assignee: SURFACE INNOVATIONS LIMITED, Milton Park, Abington, Oxfordshire (GB)

(21) Appl. No.: 14/652,804

(22) PCT Filed: Dec. 16, 2013
(86) PCT No.: PCT/GB2013/053303

§ 371 Date: Jun. 17, 2015

(30) Foreign Application Priority Data
Dec. 18, 2012 (GB) 1222841.7

(51) Int. Cl. H01B 1/12; B05D 1/00; B05B 17/06

(52) U.S. Cl. CPC H01B 1/127; B05B 17/06; B05D 1/60

(57) ABSTRACT

There is described a method for the vapour phase deposition of an intrinsically conducting polymer onto a substrate, which method comprises providing a precursor for the polymer and coupling the precursor together to form the required polymer, wherein the precursor is provided in the form of an atomised spray and substrates produced by such methods.

### FIELD OF THE INVENTION

This invention relates to methods for the deposition of electrically conductive polymers onto a substrate and to substrates made according to such methods.

### BACKGROUND TO THE INVENTION

Conductive polymers or intrinsically conducting polymers (ICPs) are organic polymers that conduct electricity. They are currently being proposed for use in a rapidly expanding range of applications as the electrical and physical properties of the ICPs are improved. Applications proposed for ICPs include use in antistatic materials, batteries, organic solar cells, printing electronic circuits, organic light-emitting diodes, actuators, electrochromism, supercapacitors, chemical sensors and biosensors, flexible transparent displays, field-effect transistors, electroluminescent devices, photochemical resists, non-linear optic devices and electromagnetic shielding. More specifically the ICP poly(3,4-ethylenedioxythiophene) (PEDOT) has found application in dye-sensitized solar cells, supercapacitors, light emitting diodes, thin film transistors, oxygen reduction catalysts, photodetectors, molecular wires, memory storage and antistatic coatings. PEDOT may be used in static or dynamic applications, where a potential is applied to a polymer film. PEDOT may be used, for example, in windows and mirrors, which can become opaque or reflective upon the application of an electric potential.

Further applications are anticipated as the present shortcomings associated with ICPs are overcome. Such shortcomings include difficulties involved in processing ICPs, which are being overcome in part by the use of nanostructures, such as nanolayers, of the ICP, and difficulties involved in their manufacture.

There are many conventional methods for the synthesis of intrinsically conductive polymers. Generally there are prepared from smaller precursor molecules, e.g. monomeric precursors, by coupling the precursors together to form the required polymer. The coupling can be carried out using a variety of chemical or electrochemical methods, e.g. chemical coupling may be by oxidative coupling. The coupling can be instigated by various techniques. Previous techniques used for the synthesis of ICPs, such as PEDOT, have entailed photo-electrochemical deposition, electro-polymerization, oxidative polymerization, oxidative chemical vapour deposition, vapour-phase polymerization, emulsion polymerization, and suspension polymerization.

There are many problems associated with the conventional methods of manufacture. In particular, the previously used techniques suffer from drawbacks such as the need of additional steps to remove solvents and by-products, and the requirement for conducting substrates or elevated temperatures, which leads to high manufacturing costs. Other problems arise due to the low solubility of the precursor molecules or of the polymers. There is, therefore, a need to provide alternative methods for the preparation of ICPs, which methods overcome or mitigate the problems associated with the previously known methods.

### STATEMENTS OF THE INVENTION

According to a first aspect of the present invention there is provided a method for the vapour phase deposition of an intrinsically conducting polymer onto a substrate, which method comprises providing a precursor for the polymer and coupling the precursor together to form the required polymer, wherein the precursor is provided in neat form and for the coupling step the precursor is supplied in the form of an atomised spray.

By providing the neat precursor in the form of an atomised spray difficulties involved with lack of solubility are avoided as is the need to heat the precursor in order to get it into the vapour phase.

The term atomized spray is used interchangeably herein with the term aerosol.

Using the atomized spray deposition approach of the present invention the precursor is provided, e.g. it is introduced into the reactor in which the method is being carried out, in the form of a fine mist of droplets.

It has been found that droplet size has an advantageous effect on the method of the present invention. Too large a droplet size may lead to an incomplete reaction taking place. The droplet size is suitably within the range of 1 micron to 200 microns for the average diameter of the droplet, preferably between 10 and 50 microns average diameter for droplet size.

Suitable means for forming the atomised spray will be well known to the skilled man. They will include gas atomised spray formation, in which a high pressure gas jet impinges on the precursor, which is either in the liquid phase or in solution, so as to cause atomisation into droplets. The precursor is preferably provided by means of an atomizing nozzle. Ultrasonic nozzles are particularly suitable forms of spray nozzle. Such nozzles use high frequency vibration, e.g. in the range 15 kHz to 200 kHz (20 to 180 kHz), to produce very narrow drop size distribution and low velocity spray from the precursor.

The atomisation of the precursor may be controlled so as to produce the required drop size, e.g. by varying the frequency of vibration, flow rate through the nozzle and the form in which the precursor is provided.

Control of the flow rate is important. It may be adjusted according to the size and nature of the reaction chamber being used and/or the frequency at which the atomiser is being operated. Suitable flow rates are in the range of 1 μL s⁻¹ to 1 mL s⁻¹ and preferably within the range 0.01 to 0.05 mL s⁻¹. For an atomizer operating at 120 kHz the flow rate is suitably in the range of approximately 0.01 to 0.05 mL s⁻¹. A flow rate of approximately 0.02 mLs⁻¹ has been found particularly suitable for liquid passing through an ultrasonic nozzle operating at around 120 kHz.

The term neat will be well understood by the skilled person and is used herein to indicate that the precursor is not provided in the form of a solution. The provision of neat precursor is advantageous as it is not necessary to remove the solvent after coupling, e.g. from the area in which the reaction is carried out. In a preferred embodiment the precursor is in the form of a liquid under the conditions in which it is provided.

It is preferred that the method of the present invention is carried out at ambient temperatures.

The vapour phase deposition of the present invention may be carried out at ambient pressure, at low pressure or at a high or an ultra-high vacuum (e.g. at very low pressure of 10⁻⁷ Pa). In a preferred embodiment the method is carried out in a low pressure, e.g. at a low sub atmospheric pressure. Using low sub atmospheric pressure reaction conditions are easily produced, unwanted side reactions may be minimised and polymer deposition on the substrate may be more uniform than under other atmospheric conditions. Suitable sub atmospheric pressure is in the range of 0.001 mbar to 500 mbar with a preferred range of 0.1 mbar to 10 mbar. It has been found that the method of the present invention may be carried out advantageously at a sub atmospheric pressure in the range 3 to 8 mbar, e.g at a pressure of approximately 6 mbar.

Although the method of the present is termed a vapour deposition method other deposition methods may be used in conjunction with the required atomized spray or precursor, for example to increase vapour density (e.g. an elevated temperature may be used and the use of an inert carrier gas such as helium or argon may be advantageous) or to aid deposition (e.g. plasma, photons, electrons, or ions may be used).

It is also to be noted that whilst the method is termed a vapour phase deposition (since it is in the vapour phase that at least a part of the reaction occurs), the atomized spray introduces liquid droplets of the precursor so that the term vapour phase deposition is to include methods in which some but not necessarily all of the reactants are in the vapour phase.

The coupling can be carried out using a variety of chemical or electrochemical methods. It is preferred that the coupling of the precursor together to form the required polymer is effected by means of an active agent. It is particularly preferred that the coupling be effected by chemical coupling, in particular oxidative coupling. The active agent may be a catalyst or reactive agent for effecting the chemical coupling. The catalyst or reactive agent may be such as to be able to effect cross-coupling. Where the coupling is oxidative coupling the active agent will be an oxidizing agent or oxidant.

Suitable catalysts and active agents will be well known to the skilled man and will depend upon the nature of the coupling to be effected, the nature of the precursor as well as the nature of the polymer to be prepared. It is preferred that the active agent is in the vapour phase under the conditions in which the method is carried out. Problems involved with solubility and the need to heat the active agent in order to get it into the vapour phase are thereby avoided.

It is also preferred that all by-products of the coupling process be in the vapour phase under the reaction conditions so that they may be easily removed, e.g. by gas flow through the reaction chamber.

Where the coupling is oxidative coupling, suitable oxidizing agents include transition metal oxidants, such as nickel and aluminium, oxides and peroxides, such as, permanganate [MnO₄]⁻, chromate [CrO₄]²⁻, osmium tetroxide [OsO₄], and perchlorate [ClO₄] and iron oxidants. Previous methods for the vapour-phase polymerization of PEDOT from the precursor ethylene dioxythiophene (EDOT) have utilized oxidants such as iron (III) chloride or iron (III) tosylate which require an additional washing step to remove the unwanted iron (II) salt by-product. In the case of using bromine vapour as the oxidant (which alleviates the need for a washing step) there still remains the requirement for heating the precursor due to the generally low vapour pressure of precursors at room temperature.

It is preferred that the oxidizing agent is in the vapour phase under the conditions in which the method is carried out. This removes the need for an additional step of transforming the oxidant into the vapour phase. It is also preferred that any by-products formed by the oxidizing agent are in the vapour phase under the conditions in which the method is carried out. If the oxidizing agent and any by-products formed are in the vapour phase they may be easily removed from the prepared polymer without the need for washing.

In a preferred embodiment the oxidizing agent is an anhydride. Suitable anhydrides include trifluoroacetic anhydride, acetic anhydride, heptafluorobutyric anhydride, pentafluoropropionic anhydride and trifluoromethane sulfonic acid anhydride.

In one embodiment of the present invention the oxidizing agent is trifluoromethane sulfonic acid anhydride (triflic anhydride). Triflic anhydride has the chemical formula (CF₃SO₂)₂O. The triflic anhydride is preferably in the form of triflic anhydride vapour under the reaction conditions in which the method is carried out. Oxidation of the precursor, e.g. EDOT monomer, by triflic anhydride leads to polymerization of the precursor into the required polymer, whilst the triflic anhydride is reduced to produce triflic and triflinic acid (CF₃SO₂H and CF₃SO₃H). By carrying out the deposition under suitable conditions, e.g. under sub atmospheric pressure, the triflic and triflinic acid by-products are in the vapour phase and can be pumped away easily avoiding the need to wash.

It is preferred that the oxidizing agent is also able to contribute to the doping of the polymer. Trifluoromethane sulfonic acid anhydride is a particularly preferred oxidizing agent as the resultant trifluoromethane sulfonic acid can be used to dope the polymer. In this case it is presently considered that the doping occurs as a result of the triflate anion being produced; when this happens the reaction may not go through the intermediate step of forming a triflic acid molecule and then back to triflate.

The precursor and active agent may be introduced separately or in combination. The precursor and active agent may be supplied simultaneously or successively. The active agent may be supplied before, during and/or after, e.g. for a period of time after, deposition has taken place.

Suitable conductive polymers or intrinsically conducting polymers (ICPs) will be well known to the skilled man. Suitable polymers include for example polypyrrole, polythiophene, polyalkylthiophene, polyacetylene, polyphenylene vinylene), poly(phenylene sufide), polyflourene, polyphenylene, polypyrene, polyazulene, polynaphthalene, polycarbazole, polyindole, polyazepine and polyaniline and copolymers thereof. Preferred polymers include polypyrrole, polythiophene or polyalkylthiophene.

In a preferred embodiment the polymer is polyalkylthiophene, in particular the polymer is poly(3,4-ethylenedioxythiophene) (PEDOT). PEDOT is preferred as it has the many advantages such as high stability, low redox potential and suitable band gap. Polypyrroles (PPs) and polythiophenes (PTs) may be prepared from the polymerisation of the precursor pyrrole or thiophene respectively.

Polyalkylthiophenes may be prepared from the polymerisation e.g. by cross-coupling or oxidative coupling, of the precursor alkylthiophene.

Polypyrroles, polythiophenes and polyalkylthiophenes may be prepared by electrochemical polymerization, e.g. by applying a potential across a solution containing thiophene and an electrolyte. Polypyrroles, polythiophenes and polyalkylthiophenes are more advantageously prepared by chemical polymerization e.g. by cross-coupling or oxidative coupling. Cross-coupling may be effected using bromo-pyrrole, thiophene or alkylthiophene precursors. Oxidative coupling may be carried out using the oxidizing agents described above.

In one embodiment of the present invention the poly alkylthiophene poly(3,4-ethylenedioxythiophene) (PEDOT) is prepared from the polymerisation e.g. by the oxidative coupling, of the precursor 3,4-ethylenedioxythiophene (EDOT).

Polyacetylene may be prepared by polymerizing the precursor acetylene or by ring opening of the precursor cyclooctatraene. Poly(phenylene vinylene) (PPV) can be synthesized by coupling the bis(ylide) derived from an aromatic bisphosphonium salt and dialdehyde, especially 1,4-benzenedialdehyde.

Polyaniline may be prepared by the oxidative coupling of the precursor aniline using ammonium peroxodisuphate as the oxidant. Suitable synthetic reactions for the polymerization of other precursors are well known to the skilled man.

The precursor is preferably a monomer.

In the method of the present invention the deposition of the polymer is onto a substrate. It is particularly preferred that the polymer is deposited as a layer, more preferably as a thin layer such as a microlayer or microcoating or in some cases as a nanolayer or nanocoating. The deposition may be applied to the surface in a layer having a thickness of for example 10 micrometres or greater. The layer may have a thickness of up to 500 μm, or of up to 250 μm or from 50 to 150 μm, e.g. of approximately 100 μm.

Suitable substrates will be well known to the skilled man and will include silicon materials and porous or non-porous, woven or non-woven materials, as well as Pt, Au, glassy carbon and indium tin oxide substrates. Further suitable substrates include silicon wafer pieces, borosilicate glass pieces and surface electrodes, e.g. evaporated gold surface electrodes. Other suitable substrates include ceramics (e.g. for electronics applications).

The atomized spray deposition method according to the present invention is advantageous as it provides a one-step vapour deposition method. The atomized spray deposition method according to the present invention is also advantageous as it a completely dry process.

The atomized spray deposition method according to the present invention approach can be easily scaled up to industrial scale, for example using roll-to-roll processing, to provide high throughput, conformal, electrically conductive polymer coatings. A polymer which has been applied to a substrate surface using the deposition method according to the present invention will typically exhibit good adhesion to the substrate surface. The applied polymer will typically form as a uniform conformal coating over the entire area of the substrate which is exposed to the relevant precursor during the deposition process, regardless of substrate geometry or surface morphology.

In a specific embodiment of the present invention there is provided a method for the vapour phase deposition of the intrinsically conductive polymer poly (3,4-ethylenedioxythiophene) onto a substrate, which method comprises providing 3,4-ethylenedioxythiophene as a precursor for the polymer and chemically coupling the precursor to form the required polymer by oxidative coupling using an oxidizing agent, wherein the 3,4-ethylenedioxythiophene precursor is provided in neat form and for the coupling step the 3,4-ethylenedioxythiophene precursor is supplied in the form of an atomised spray.

The oxidizing agent used in the specific embodiment is preferably triflic anhydride.

In the specific embodiment the the triflic anhydride is preferably in the vapour phase during the coupling step. The method is preferably carried out using sub atmospheric pressure.

According to a second aspect of the present invention there is provided a method for the vapour phase deposition of an intrinsically conducting polymer onto a substrate, which method comprises providing a precursor for the polymer and coupling the precursor together to form the required polymer by means of an active agent, wherein the active agent is triflic anhydride.

In a preferred embodiment of the second aspect of the present invention the coupling is oxidative coupling and the triflic anhydride is acting as an oxidising or oxidative agent.

In the method of the second aspect of the present invention the precursor may be provided in the form of an atomised spray. The droplet size of the precursor is suitably within the range of 1 micron to 200 microns for the average diameter of the droplet, preferably between 10 and 50 microns average diameter for droplet size. Suitable means for forming an atomised spray of the precursor will be well known to the skilled man and include all of those listed above for the first aspect of the invention.

In a preferred embodiment of the second aspect of the present invention the precursor is provided in neat form. The provision of neat precursor is advantageous as it is not necessary to remove any solvent after coupling, e.g. from the area in which the reaction is carried out. In a preferred embodiment the precursor is in the form of a liquid under the conditions in which it is provided.

Suitable flow rates for supplying the precursor are in the range of 1 μL s⁻¹ to 1 mL s⁻¹ and preferably within the range 0.01 to 0.05 mL s¹. For an atomizer operating at 120 kHz the flow rate is suitably in the range of approximately 0.01 to 0.05 mL s⁻¹. A flow rate of approximately 0.02 mLs⁻¹ has been found particularly suitable for liquid passing through an ultrasonic nozzle operating at around 120 kHz.

It is preferred that the method of the second aspect of the present invention is carried out at ambient temperatures.

The vapour phase deposition of the second aspect of the present invention may be carried out at ambient pressure, at low pressure or at a high or an ultra-high vacuum (e.g. at very low pressure of 10⁻⁷ Pa), as described above for the first aspect of the invention.

Although the method of the second aspect of the present invention is termed a vapour deposition method other deposition methods may be used in conjunction with the required atomized spray or precursor, for example to increase vapour density (e.g. an elevated temperature may be used and the use of an inert carrier gas such as helium or argon may be advantageous) or to aid deposition (e.g. plasma, photons, electrons, or ions may be used).

It is preferred that the triflic anhydride is in the vapour phase under the conditions in which the method of the second aspect of the present invention is carried out. This removes the need for an additional step of transforming the oxidant into the vapour phase. It is also preferred that any by-products formed by the triflic anhydride active agent are in the vapour phase under the conditions in which the method is carried out. If the active agent and any by-products formed are in the vapour phase they may be easily removed from the prepared polymer without the need for washing.

Coupling, e.g. oxidation of the precursor, e.g. EDOT monomer, by triflic anhydride leads to polymerization of the precursor into the required polymer, whilst the triflic anhydride is reduced to produce triflic and triflinic acid (CF₃SO₂H and CF₃SO₃H). By carrying out the deposition under suitable conditions, e.g. under sub atmospheric pressure, the triflic and triflinic acid by-products are in the vapour phase and can be pumped away easily avoiding the need to wash.

Triflic anhydride is advantageous as it is able to contribute to the doping of the polymer.

Suitable conductive polymers or intrinsically conducting polymers (ICPs) will be well known to the skilled man and include all those listed above for the first aspect of the present invention.

In the method of the second aspect of the present invention the deposition of the polymer is onto a substrate. It is particularly preferred that the polymer is deposited as a layer, more preferably as a thin layer such as a microlayer or microcoating or in some cases as a nanolayer or nanocoating. The deposition may be applied to the surface in a layer having a thickness of for example 10 micrometres or greater. The layer may have a thickness of up to 500 μm, or of up to 250 μm or from 50 to 150 μm, e.g. of approximately 100 μm.

Suitable substrates will be well known to the skilled man and include those listed above for the first aspect of the present invention.

According to a third aspect of the present invention there is provided a substrate provided with a layer of an intrinsically conductive polymer that has been deposited using a method according to either the first or the second aspect of the present invention.

The substrate of the third aspect of the present invention is preferably provided with a poly(3,4-ethylenedioxythiophene) layer.

The substrate of the third aspect of the present invention may be made from any suitable material. It may be adapted in form or shape to suit the method of use or application. Suitable materials will be well known to the skilled person and include silicon materials and porous or non-porous, woven or non-woven materials, as well as Pt, Au, glassy carbon and indium tin oxide substrates. Further suitable substrates include silicon wafer pieces, borosilicate glass pieces and surface electrodes, e.g. evaporated gold surface electrodes. Other suitable substrates include ceramics (e.g. for electronics applications).

The substrate of the third aspect of the present invention may be used in a wide variety of applications. Potential applications include use in antistatic materials, batteries, organic solar cells, printing electronic circuits, organic light-emitting diodes, actuators, electrochromism, supercapacitors, chemical sensors and biosensors, flexible transparent displays, field-effect transistors, electroluminescent devices, photochemical resists, non-linear optic devices and electromagnetic shielding. More specifically substrates with an poly(3,4-ethylenedioxythiophene) layer may have application in dye-sensitized solar cells, supercapacitors, light emitting diodes, thin film transistors, oxygen reduction catalysts, photodetectors, molecular wires, memory storage and antistatic coatings. They may be used in static or dynamic applications, for example, in windows and mirrors, which can become opaque or reflective upon the application of an electric potential.

The substrate is preferably provided with a layer of polymer that has been deposited on it, which layer is a thin layer such as a microlayer or microcoating or in some cases a nanolayer or nanocoating. The substrate may be provided with a layer having a thickness of for example 10 micrometres or greater. The layer may have a thickness of up to 500 μm, or of up to 250 μm or from 50 to 150 μm, e.g. of approximately 100 μm.

The electrical conductivity of the polymer deposited on the substrate may be in the range of 0.7 to 1.1 scm⁻¹, e.g. approximately 0.9 S cm ⁻¹, and to have an ohmic response across the 0-50, e.g. 0-30, V range.

The present invention is advantageous as it provides an improved method for the deposition of ICPs. The present invention is advantageous as it overcomes the problems associated with known methods of deposition of ICPs. Using the present invention, unlike with previous vapour-phase deposition processes, which require a separate washing step to remove unwanted by-products, the reaction may be completely dry. There is also no need for high temperatures in order to vaporize the precursor, such as the monomer EDOT, as the precursor is introduced as an atomized spray. The method can be carried out at ambient temperatures. This leads to ease of manufacture and lower costs. The method is advantageous as it uses an atomized spray rather than an elevated temperature to effect a higher concentration of reactants. The method is also advantageous in its novel use of triflic anhydride as the oxidiser. The electrical conductivity of the deposited ICP is sufficiently high for extensive application, e.g. as antistatic coatings or in electrochemical devices (such as capacitor electrodes). By-products may be easily pumped away thereby avoiding acid damage to the growing polymer chains. The method of the present invention allows for single-step, solvent-less, and low energy consumption methods of the deposition of ICPs. The methods are easily scalable to industrial practice.

Throughout the description and claims of this specification, the words “comprise” and “contain” and variations of the words, for example “comprising” and “comprises”, mean “including but not limited to”, and do not exclude other moieties, additives, components, integers or steps. Moreover the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Other features of the invention will become apparent from the following examples. Generally speaking the invention extends to any novel one, or any novel combination, of the features disclosed in this specification (including any accompanying claims and drawings). Thus features, integers, characteristics, compounds, chemical moieties or groups described in conjunction with a particular aspect, embodiment or example of the invention are to be understood to be applicable to any other aspect, embodiment or example described herein unless incompatible therewith. Moreover unless stated otherwise, any feature disclosed herein may be replaced by an alternative feature serving the same or a similar purpose.

Where upper and lower limits are quoted for a property, for example for the concentration of a component, then a range of values defined by a combination of any of the upper limits with any of the lower limits may also be implied.

### DETAILED DESCRIPTION

The present invention will now be further described with reference to the following non-limiting example and the accompanying figures, of which:

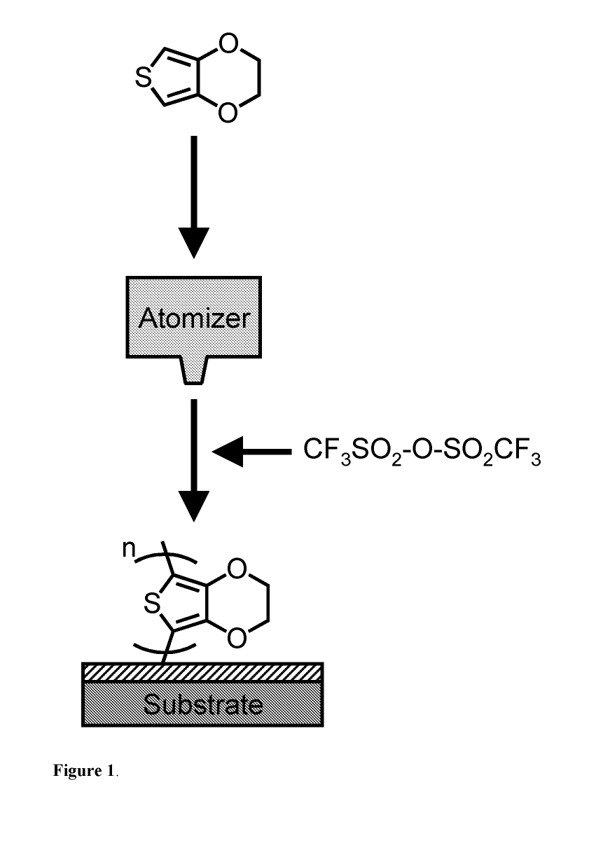

FIG. 1 shows schematically a method in accordance with the first aspect of the present invention;

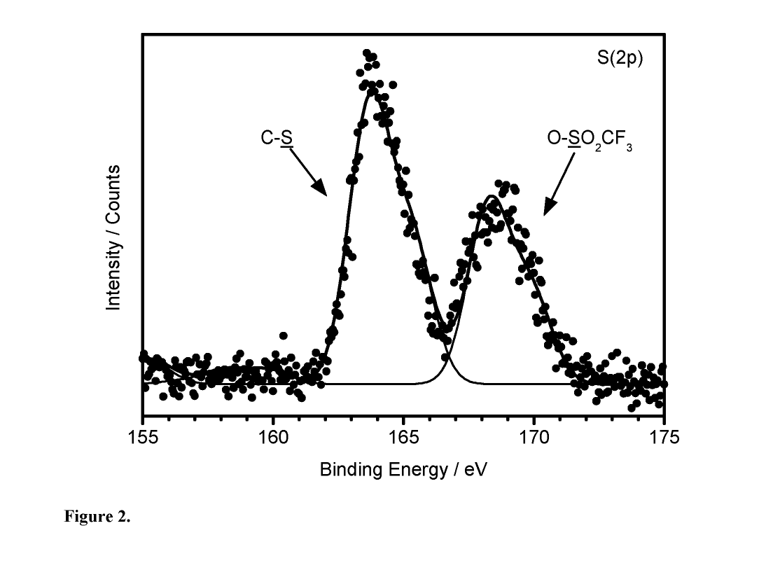

FIG. 2 shows an X-ray photoelectron spectrum of the atomized spray deposited polymer produced in Example 1 below; and

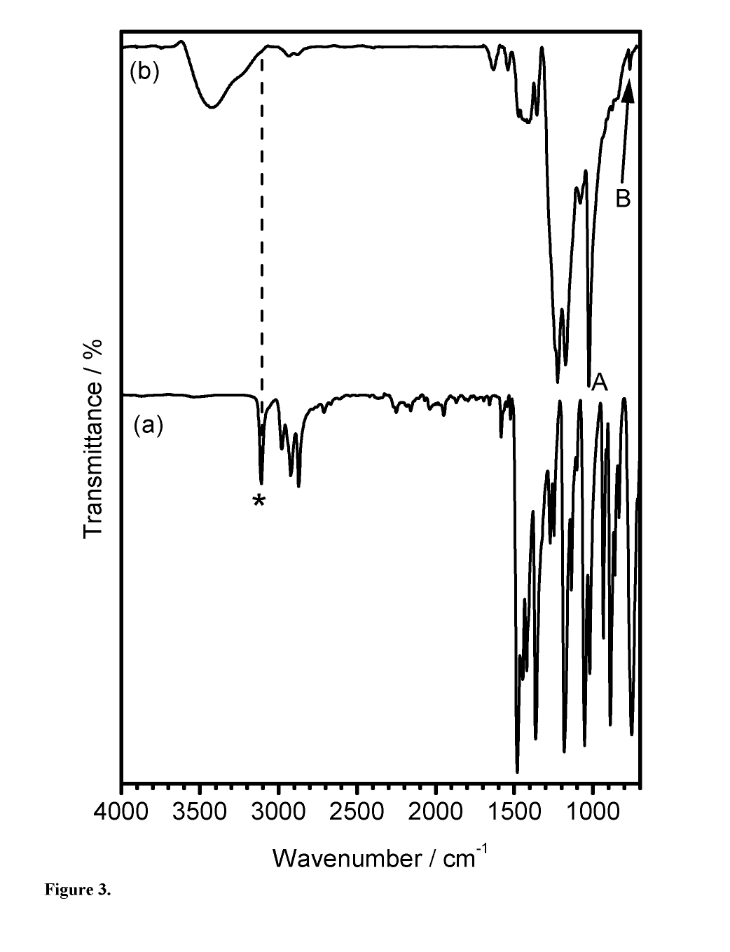

FIG. 3 shows a Fourier transform infrared spectra of the precursor used and the deposited layer produced in Example 1 below.

The scheme shown in FIG. 1 illustrates a method that uses an atomized spray of the precursor 3,4-thylenedioxythiophene (EDOT) for the deposition of poly(3,4-thylenedioxythiophene) (PEDOT) layers in the presence of triflic anhydride vapour. Oxidation of the EDOT monomer leads to polymerization, whilst triflic anhydride reduction produces triflic and triflinic acid. The triflic anhydride acts as an oxidant in the following reaction:

2EDOT+(CF₃SO₂)₂O→EDOT-EDOT+CF₃SO₂H+CF₃SO₃H.

### EXAMPLE 1

Oxidative Atomized Spray Deposition of PEDOT Layers:

Atomized spray deposition was carried out in an electrode-less, cylindrical, T-shape, glass reactor (volume 820 cm³, base pressure of 3×10⁻³ mbar, and with a leak rate better than 2×10⁻⁹ mol s⁻¹). The chamber was pumped down using a 30 L min⁻¹ rotary pump attached to a liquid nitrogen cold trap, and the system pressure was monitored with a Pirani gauge. Prior to each deposition, the reactor was scrubbed using detergent, rinsed in propan-2-ol, and dried in an oven. Substrates used for coating were silicon (100) wafer pieces (Silicon Valley Microelectronics Inc.) and borosilicate glass microscrope slide pieces (Smith Scientific Ltd.), with two evaporated gold surface electrodes. These were placed downstream from the atomizer nozzle (Model No. 8700-120, Sono Tek Corp.).

3,4-Ethylenedioxythiophene (+98%, TCI Europe NV) and triflic anhydride (+99%, Apollo Scientific Ltd.) were loaded into separate sealable glass tubes and degassed using several freeze-pump-thaw cycles. 3,4-Ethylenedioxythiophene precursor was then introduced into the reaction chamber at a flow rate of 0.02 mL s⁻¹ by passing through the ultrasonic nozzle operating at 120 kHz, while triflic anhydride vapour was co-fed via a leak valve at a pressure of 6 mbar. Upon completion of deposition, triflic anhydride vapour was allowed to pass through the system for a further 3 min prior to evacuation to base pressure and finally venting to atmosphere.

Film Characterization:

Surface elemental compositions were determined by X-ray photoelectron spectroscopy (XPS) using a VG ESCALAB II electron spectrometer equipped with a non-monochromated Mg Kα X-ray source (1253.6 eV) and a concentric hemispherical analyser. Photoemitted electrons were collected at a take-off angle of 20° from the substrate normal, with electron detection in the constant analyser energy mode (CAE, pass energy=20 eV). Experimental instrument sensitivity (multiplication) factors were C(1s):O(1s):S(2p):F(1s) equals 1.00:0.36:0.59:0.24. All binding energies were referenced to the C(1s) hydrocarbon peak at 285.0 eV. A linear background was subtracted from core level spectra and then fitted using Gaussian peak shapes with a constant full-width-half-maximum (fwhm).

Infrared spectra were acquired using a FTIR spectrometer (Perkin-Elmer Spectrum One) fitted with a liquid nitrogen cooled MCT detector operating at 4 cm⁻¹ resolution across the 700-4000 cm⁻¹ range. Attenuated-total-reflection spectra were obtained using a Golden Gate accessory (Specac Ltd.).

Film thicknesses were measured by freezing coated silicon samples in liquid nitrogen followed by snapping to reveal a cross-section. These were then imaged using an optical microscope (Olympus BX40) fitted with a ×20 magnification lens. Electrical conductivity values were obtained for the coated glass substrates by measuring the variation in electrical current across the 0-30 V range (Keithley 2400 SourceMeter), extracting the resistance of the films (Rₛ) via Ohm's law, and applying the formula σ=1/(RₛA) where 1=separation of the electrodes, A=the cross-sectional area of the film, and σ=the conductivity of the film.

Results:

The X-ray photoelectron spectrum of the atomized spray deposited polymer produced is shown in FIG. 2. The absence of any XPS Si(2p) signal confirmed pinhole-free coverage of the substrates following the atomized spray deposition of PEDOT in the presence of triflic anhydride vapour. The S(2p) spectrum contains two components corresponding to the thiophene ring C—S (163.7 eV) and triflate O—SO₂CF₃ (168.3 eV), see FIG. 2. The measured ratio of the respective S(2p) component peaks corresponds to approximately one triflate or triflinate ion to every three EDOT monomer units. This ratio was consistent with the value of 1:2.7 calculated using the F(1s) peak area as a proportion of the elemental XPS concentrations as compared to the theoretical (non-doped) EDOT polymer, see Table 1.

TABLE 1
XPS elemental ratios of atomized spray deposited PEDOT in the
presence of triflic anhydride vapour.

| layer | % C | % O | % S | % F |
|---|---|---|---|---|
| Theoretical PEDOT | 67 | 22 | 11 | — |
| Atomized spray | 54 ± 1 | 24 ± 1 | 11 ± 1 | 11 ± 1 |
| deposited PEDOT- | | | | |
| triflic anhydride | | | | |

The Fourier transform infrared spectra of the precursor used and the deposited layer produced is shown in FIG. 3. In FIG. 3 (a) shows the EDOT monomer and (b) the atomized spray deposited PEDOT-trflic anhydride. * denotes ═C—H ring stretch; A denotes SO₃ symmetric stretch; and B denotes CF₃ stretch. The Fourier transform infrared spectrum of the EDOT precursor displays the following absorbances:═C—H ring stretch (3107 cm⁻¹), antisymmetric CH₂ stretch (2919 cm⁻¹), symmetric CH₂ stretch (2869 cm⁻¹), C═C aromatic out of phase stretch (1479 cm⁻¹), C═C aromatic in phase stretch (1444 cm ⁻¹), and C—C deformation (1369 cm ⁻¹), see FIG. 3.

Following the atomized spray deposition of the poly(3,4-ethylenedioxythiophene)-triflic anhydride coating, the ═C—H ring stretch has disappeared (which is consistent with polymerization via the 2-position on the thiophene ring), the CH₂ stretches remain confirming retention of the ethylenedioxy substituent, the aromatic vibration absorbances in the fingerprint region have broadened out (which is consistent with a doped conjugated polymer system), and there is the appearance of absorbances due to triflate SO₂ symmetric stretch (1083 cm ⁻¹, denoted A) and CF₃ symmetric stretch (762 cm⁻¹, denoted B). Deposition rates for the atomized spray deposition of PEDOT-triflic anhydride films were measured to be 2.9±0.4 μm min⁻¹. Electrical conductivity measurements for the atomized spray deposited PEDOT-triflic anhydride layers gave a value of 0.9 S cm⁻¹ and showed an ohmic response across the 0-30 V range.

Conclusion:

Atomised spray deposition of 3,4-ethylenedioxythiophene monomer in the presence of triflic anhydride vapour yields electrically conducting poly(3,4-ethylenedioxythiophene) layers.

In contrast to known methods of PEDOT synthesis, the outlined oxidative atomized spray deposition approach circumvents the need for post-deposition washing (since the triflic acid or triflinic acid by-products are pumped off), and it is not necessary to heat the precursor because it is introduced in the form of a fine mist of droplets into the reactor at ambient temperatures.

The electrical conductivity of the deposited PEDOT-triflic anhydride films reaches a value of 0.9 S cm ⁻¹, which is sufficiently high enough for application as an antistatic coating or in electrochemical devices (such as capacitor electrodes).

This oxidative atomized spray deposition approach can be easily scaled using roll-to-roll processing to provide high throughput, conformal, electrically conductive polymer coatings.

By carrying out the deposition under sub atmospheric pressure, the triflic and triflinic acid by-products may be easily pumped away thereby avoiding acid damage to the growing polymer chains. Akin to other oxidative polymerization mechanisms for EDOT partial doping happens by the remaining oxidant (triflate) anions.

Unlike previous vapour-phase deposition processes, which require a separate washing step to remove unwanted by-products, this method is a one-step process that is completely dry and there is no need for high temperatures in order to vaporize the monomer, since the EDOT precursor is introduced as an atomized spray.

1. A method for the vapour phase deposition of an intrinsically conducting polymer onto a substrate comprising providing a precursor for the polymer and coupling the precursor together to form the required polymer, wherein the precursor is provided in neat form and, for the coupling step, the precursor is supplied in the form of an atomised spray.

2. The method of claim 1, wherein the atomised spray consists essentially of droplets, wherein the droplet size of the precursor in the atomised spray is about 1 micron to 200 microns average diameter of droplet.

3. The method of claim 2, wherein the droplet size of the precursor in the atomised spray is 10 to 50 microns average diameter of droplet.

4. The method of claim 1, wherein the atomised spray is formed by an ultrasonic nozzle operating at a high frequency vibration of about 15 kHz to 200 kHz.

5. The method of claim 4, wherein the flow rate of the precursor through the nozzle is about 1 μL s⁻¹ to 1 mL s⁻¹.

6. The method of claim 1, wherein the vapour phase deposition is carried out at a sub atmospheric pressure.

7. The method of claim 6, wherein the sub atmospheric pressure is about 0.001 mbar to 500 mbar.

8. The method of claim 1, wherein the coupling of the precursor is effected by means of an active agent and the active agent is in the vapour phase under the conditions in which the coupling is carried out.

9. The method of claim 1, wherein the coupling is oxidative coupling effected by means of an oxidizing agent.

10. The method of claim 9, wherein the oxidizing agent is an anhydride.

11. The method of claim 9, wherein the oxidizing agent is selected from the group consisting of trifluoroacetic anhydride, acetic anhydride, heptafluorobutyric anhydride, pentafluoropropionic anhydride and trifluoromethane sulfonic acid anhydride.

12. The method of claim 9, wherein the oxidizing agent is trifluoromethane sulfonic acid anhydride (triflic anhydride).

13. The method of claim 1, wherein the intrinsically conducting polymer is a polypyrrole, a polythiophene, a polyalkylthiophene, a polyacetylene, a poly(phenylene vinylene), a poly(phenylene sulfide), a polyflourene, a polyphenylene, a polypyrene, a polyazulene, apolynaphthalene, a polycarbazole, a polyindole, a polyazepine, a polyaniline or a copolymer thereof.

14. The method of claim 13, wherein the intrinsically conducting polymer is a polypyrrole, a polythiophene, a polyalkylthiophene or a copolymer thereof.

15. The method of claim 13, wherein the intrinsically conducting polymer is poly(3,4-ethylenedioxythiophene) (PEDOT) and the precursor is 3,4-ethylenedioxythiophene (EDOT).

16. A method for vapour phase deposition of intrinsically conductive polymer poly(3,4-ethylenedioxythiophene) onto a substrate comprising providing 3,4-ethylenedioxythiophene as a precursor for the polymer, and chemically coupling the precursor to form the required polymer by oxidative coupling using an oxidizing agent, wherein the 3,4-ethylenedioxythiophene precursor is provided in neat form and, for the coupling step, the 3,4-ethylenedioxythiophene precursor is supplied in the form of an atomised spray.

17. The method of claim 16, wherein the oxidizing agent is triflic anhydride.

18. The method of claim 17, wherein the triflic anhydride is in the vapour phase under the conditions in which the method is carried out.

19. A method for the vapour phase deposition of an intrinsically conducting polymer onto a substrate comprising providing a precursor for the polymer and coupling the precursor together to form the required polymer by means of an active agent, wherein the active agent is triflic anhydride.

20. The method of claim 19, wherein the intrinsically conducting polymer is poly(3,4-ethylenedioxythiophene) (PEDOT) and the precursor is 3,4-ethylenedioxythiophene (EDOT).

21. (canceled)
